(19) United States
(12) Patent Application Publication
(10) Pub. No.: US 2026/0105771 A1
(43) Pub. Date: Apr. 16, 2026

(54) SYSTEM AND METHOD FOR AI-ASSISTED IMAGE ANALYSIS AND DATA GENERATION FOR PATENT APPLICATIONS

(71) Applicant: Solve Intelligence, Inc., London (GB)

(72) Inventors: Sanjeevan Ahilan, London (GB); Angus Parsonson, London (GB); Chris Parsonson, London (GB); Justin Doop, London (GB)

(21) Appl. No.: 19/359,377

(22) Filed: Oct. 15, 2025

Related U.S. Application Data
(60) Provisional application No. 63/708,081, filed on Oct. 16, 2024.

(51) Int. Cl. G06V 30/422; G06F 40/166; G06F 40/40; G06Q 50/18; G06V 10/40; G06V 10/94; G06V 20/70

(52) U.S. Cl. CPC G06V 30/422; G06F 40/166; G06F 40/40; G06Q 50/184; G06V 10/40; G06V 10/945; G06V 20/70

(57) ABSTRACT

The present disclosure provides a method for generating data using artificial intelligence based on image analysis. The method includes obtaining an image by a computing device, providing the image to a first artificial intelligence model, and generating an analysis of the image using the first artificial intelligence model. The analysis of the image is provided to a user, and a primary user input adjusting the analysis of the image is received to form a user-adjusted analysis. The user-adjusted analysis is then provided to a second artificial intelligence model. Data is generated using the second artificial intelligence model based on the user-adjusted analysis. The method allows for user interaction and refinement of AI-generated image analysis to improve the accuracy and relevance of the final generated data.

### CROSS REFERENCE TO RELATED APPLICATIONS

This application claims the benefit of U.S. Application No. 63/708,081, filed on Oct. 16, 2024, and entitled “SYSTEM AND METHOD FOR AI-ASSISTED IMAGE ANALYSIS AND DATA GENERATION FOR PATENT APPLICATIONS,” which is incorporated by reference herein in its entirety.

### REFERENCE REGARDING FEDERALLY SPONSORED RESEARCH OR DEVELOPMENT

Not applicable

### SEQUENCE LISTING

Not applicable

### BACKGROUND

### 1. Field of the Invention

The present disclosure relates to computer-implemented methods and systems for image analysis and data generation, and more particularly to a method and system for analyzing figures for patent applications using artificial intelligence models and generating data based on user-verified image analysis.

### 2. Description of the Background

Image analysis and text generation have become increasingly important in various fields, including patent drafting, technical documentation, and content creation. As technology advances, there is a growing need for efficient and accurate methods to analyze visual information and generate corresponding textual descriptions.

Traditional approaches to image analysis often rely on manual interpretation, which can be time-consuming and subject to human error. Moreover, the process of translating visual information into coherent and detailed textual descriptions presents its own set of challenges, particularly when dealing with complex technical drawings or diagrams.

Artificial intelligence and machine learning technologies have shown promise in addressing these challenges. However, many existing solutions struggle to provide a balance between automation and human oversight, often resulting in outputs that may lack accuracy or fail to capture the nuances of the analyzed images.

Furthermore, the integration of image analysis and text generation tools into existing workflows can be cumbersome, requiring users to switch between multiple applications or platforms. This lack of seamless integration can hinder productivity and create barriers to adoption, particularly in professional settings where efficiency is paramount.

As the volume of visual information continues to grow across various industries, there is an increasing demand for sophisticated tools that can streamline the process of analyzing images and generating accurate, context-appropriate data such as textual descriptions. Addressing these challenges could lead to significant improvements in productivity and accuracy across a wide range of applications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for generating data using artificial intelligence based on image analysis is provided. The method includes obtaining, by a computing device, an image. The method further includes providing the image to a first artificial intelligence model. The method also includes generating, using the first artificial intelligence model, an analysis of the image. The method further includes providing the analysis of the image to a user. The method also includes receiving a primary user input adjusting the analysis of the image to form a user-adjusted analysis. The method further includes providing the user-adjusted analysis to a second artificial intelligence model. The method also includes generating data using the second artificial intelligence model based on the user-adjusted analysis.

According to other aspects of the present disclosure, the method may include one or more of the following features. The method may further include extracting a feature from the image, generating an element label associated with the feature, providing a dataset to the user, wherein the dataset comprises the element label and a reference to an associated feature, receiving a secondary user input adjusting the dataset to form a user-adjusted dataset, and using the user-adjusted dataset to adjust the analysis of the image or further adjust the user-adjusted analysis of the image. Using the user-adjusted dataset to adjust the analysis of the image may include providing the user-adjusted dataset to the first artificial intelligence model prior to generating the analysis of the image, such that the analysis of the image is based on the user-adjusted dataset. Using the user-adjusted dataset to further adjust the user-adjusted analysis of the image may include providing the user-adjusted dataset to the first artificial intelligence model after receiving the primary user input adjusting the analysis of the image to form a user-adjusted analysis, and automatically updating the user-adjusted analysis of the image based on the user-adjusted dataset. The secondary user input may comprise an adjustment to the element label of the dataset, and adjusting the analysis of the image may comprise adjusting the analysis of the image based on the adjustment to the element label.

According to other aspects of the present disclosure, providing the analysis of the image to the user may include presenting a user interface having an editable text area comprising the analysis of the image, wherein receiving the primary user input adjusting the analysis of the image to form a user-adjusted analysis may include receiving an edit of the analysis of the image in the editable text area. The user interface may comprise one or more user interface elements for adjusting, regenerating, or saving the analysis of the image. The method may further include presenting the generated data to the user in a user interface comprising a document editor. Generating the data using the second artificial intelligence model based on the user-adjusted analysis may further include generating the data using the second artificial intelligence model based on the user-adjusted analysis and at least one of an additional instruction provided by the user and other pre-existing data input by the user to the document editor. The first artificial intelligence model may be the same model as the second artificial intelligence model.

According to another aspect of the present disclosure, a computing system for generating data using artificial intelligence based on image analysis is provided. The computing system includes a processor and a memory storing instructions that, when executed by the processor, cause the computing system to obtain an image and provide the image to a first artificial intelligence model. The processor and memory storing instructions further generate, using the first artificial intelligence model, an analysis of the image, provide the analysis of the image to a user, receive a primary user input adjusting the analysis of the image to form a user-adjusted analysis, provide the user-adjusted analysis to a second artificial intelligence model, and generate data using the second artificial intelligence model based on the user-adjusted analysis.

According to other aspects of the present disclosure, the computing system may include one or more of the following features. The instructions may further cause the computing system to extract a feature from the image, generate an element label associated with the feature, provide a dataset to the user. The dataset comprises the element label and a reference to its associated feature, receive a secondary user input adjusting the dataset to form a user-adjusted dataset, and use the user-adjusted dataset to adjust the analysis of the image or further adjust the user-adjusted analysis of the image. The instructions may cause the computing system to use the user-adjusted dataset to adjust the analysis of the image by providing the user-adjusted dataset to the first artificial intelligence model prior to generating the analysis of the image, such that the analysis of the image is based on the user-adjusted dataset. The instructions may cause the computing system to use the user-adjusted dataset to further adjust the user-adjusted analysis of the image by providing the user-adjusted dataset to the first artificial intelligence model after receiving the primary user input adjusting the analysis of the image to form a user-adjusted analysis, and automatically updating the user-adjusted analysis of the image based on the user-adjusted dataset. The secondary user input may comprise an adjustment to the element label of the dataset, and the instructions may cause the computing system to adjust the analysis of the image by adjusting the analysis of the image based on the adjustment to the element label.

According to other aspects of the present disclosure, the computing system may further comprise a user interface configured to present an editable text area comprising the analysis of the image and receive the primary user input comprising an edit of the analysis of the image in the editable text area. The user interface may comprise one or more user interface elements for adjusting, regenerating, or saving the analysis of the image. The instructions may further cause the computing system to present the generated data to the user in a user interface comprising a document editor. The memory may further store instructions that, when executed by the processor, cause the computing system to generate the data using the second artificial intelligence model based on the user-adjusted analysis and at least one of an additional instruction provided by the user and other pre-existing data input by the user to the document editor. The first artificial intelligence model may be the same model as the second artificial intelligence model.

According to another aspect of the present disclosure, a method for improving an efficiency and accuracy of a system for drafting a patent application by utilizing artificial intelligence (AI) is provided. The method includes receiving, through a user interface, a figure. The method further includes providing the figure to a first artificial intelligence model. The method also includes generating, using the first artificial intelligence model, a first analysis of the figure. The method further includes displaying the first analysis of the figure to a user. The method also includes providing the figure and the first analysis to a second artificial intelligence model. The method further includes generating, using the second artificial intelligence model, a second analysis of the figure. The method also includes displaying the second analysis of the figure to a user. The method further includes providing the figure, the first analysis, and the second analysis to a third artificial intelligence model. The method also includes generating, using the third artificial intelligence model, text related to the figure. The method further includes displaying the generated text to the user.

In some embodiments, the step of generating, using the first artificial intelligence model, the first analysis of the figure includes extracting one or more reference numerals from the figure and generating reference names for the one or more reference numerals. In further embodiments, the first artificial intelligence model, the second artificial intelligence model, and the third artificial intelligence model are the same artificial intelligence model.

According to another aspect of the present disclosure, a system with improved efficiency and performance in drafting a patent application is provided. The system includes a client device configured to display a user interface, a server communicatively coupled to the client device, and a large language model server communicatively coupled to the server. The server is configured to receive, through the user interface, a figure, provide the figure to the large language model server, receive a first analysis of the figure from the large language model server, receive user feedback from the client device in response to the first analysis of the figure, provide the figure and the first analysis of the figure to the large language model server, receive a second analysis of the figure from the large language model server, receive user feedback from the client device in response to the second analysis of the figure, provide the figure, the first analysis, and the second analysis of the figure to the large language model server, receive generated text from the large language model server, and display the generated text to the user interface.

According to another aspect of the present disclosure, a non-transitory computer-readable medium storing instructions that, when executed by a processor, cause the processor to perform operations for improving an efficiency and a performance of a system for drafting a patent application is provided. The operations include receiving, through a user interface, a figure, providing the figure to a first artificial intelligence model, generating, using the first artificial intelligence model, a first analysis of the figure, displaying the first analysis of the figure to a user, providing the figure and the first analysis to a second artificial intelligence model, generating, using the second artificial intelligence model, a second analysis of the figure, displaying the second analysis of the figure to a user, providing the figure, the first analysis, and the second analysis to a third artificial intelligence model, generating, using the third artificial intelligence model, text related to the figure, and displaying the generated text to the user.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a flowchart of a method for processing and analyzing images using artificial intelligence, according to aspects of the present disclosure.

FIG. 2 illustrates a detailed flowchart of a process for image analysis and text generation, according to an embodiment.

FIG. 3 illustrates an example image with labeled features, according to aspects of the present disclosure.

FIG. 4 illustrates a second example image with reference signs, according to an embodiment.

FIG. 5 illustrates a sequence diagram of a process for image analysis and data generation, according to aspects of the present disclosure.

FIG. 6A illustrates a user interface for image analysis and text generation, according to an embodiment.

FIG. 6B illustrates the user interface of FIG. 6A with user-edited content, according to aspects of the present disclosure.

FIG. 7 illustrates a document editor with an AI placeholder, according to an embodiment.

FIG. 8 illustrates a document editor with AI-generated text, according to aspects of the present disclosure.

FIG. 9 illustrates a sequence diagram of an alternative process for image analysis and data generation, according to an embodiment.

FIG. 10 illustrates a block diagram of a computing device, according to aspects of the present disclosure.

FIG. 11 illustrates a system architecture for a distributed computing environment, according to an embodiment.

FIG. 12 illustrates a schematic diagram of an AI model, according to aspects of the present disclosure.

FIG. 13 illustrates a schematic diagram of the AI model of FIG. 12, according to aspects of the present disclosure.

Common reference numerals are used throughout the figures to indicate similar elements.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a computer-implemented method, system, computer program product, and computer-readable medium for analyzing images and generating corresponding data using artificial intelligence (AI). This method, system, computer program product, and computer-readable medium may be particularly beneficial in the field of technical documentation and patent drafting, where the accurate translation of visual information into detailed data, such as textual descriptions, is routinely required.

The disclosed methods and systems may utilize an first artificial intelligence model to analyze an image and generate an initial analysis. This analysis may be presented to a user for review and adjustment through a primary user input. The primary user input allows for broad corrections or refinements to the AI's interpretation, ensuring accuracy and context-appropriateness of the overall analysis. The user-adjusted analysis may then be provided to a second artificial intelligence model, which uses this refined input to generate data, such as textual descriptions or other content. This two-step process, involving both AI analysis and user refinement, helps ensure that the generated data accurately reflects the user's understanding and intent, while leveraging the capabilities of AI for efficient content creation.

In some cases, the method and system may include an additional step to further enhance the accuracy of the generated data. The first artificial intelligence model may perform a second analysis to extract specific features from the image and generate element labels associated with these features. The specific features may be reference signs in the image. The system may then present the element labels to the user for verification or adjustment through a secondary user input. This second input enables more precise adjustments to specific elements within the image, providing a more granular examination of the image elements and components.

The combination of the first and secondary user inputs may create a dual-input process that allows users to iteratively refine the AI's understanding of the image at different levels of detail. The first input addresses the overall interpretation of the image, while the second input focuses on specific features and their associated labels. This approach may lead to more accurate and contextually appropriate data generation, as it provides multiple opportunities for user intervention and refinement in the AI analysis process. The second analysis and secondary user input can be performed before or after the first analysis and primary user input.

In summary, the present disclosure provides a method and system that leverages the capabilities of AI to streamline the process of analyzing images and generating corresponding data, while also allowing for human input to ensure accuracy and context-appropriateness.

The term “data” is used herein in the context of AI-generation to mean any type of information or content generated by an artificial intelligence model based on image analysis. This may include, but is not limited to, textual descriptions, labels, image data (e.g., pixels), classifications, or other forms of output derived, at least in part, from analyzing an image.

The term “feature” is used herein with reference to an image to mean a distinct element, component, or characteristic of an image that can be identified and analyzed. Features may include visual elements such as shapes, objects, textures, or patterns within the image, as well as reference signs associated with specific parts of the image.

The term “primary user input” is used herein to mean an interaction or modification provided by a user in to an analysis of an image generated by a first artificial intelligence model. This input may involve adjusting, refining, or verifying the AI-generated analysis to form a user-adjusted analysis of the image.

The term “secondary user input” is used herein to mean an interaction or modification provided by a user to a dataset including element labels and associated features extracted from an image. This input may involve adjusting or verifying the element labels or other aspects of the dataset to form a user-adjusted dataset.

The term “dataset” is used herein to mean a collection of structured information, typically including element labels associated with features of an image and the features themselves. The dataset may alternatively include an identifier corresponding to a feature rather than the feature itself. This dataset may be presented to a user for review and adjustment.

The term “adjusted dataset” is used herein to mean a dataset that has been modified or verified by a user through the secondary user input. This adjusted dataset may be used to inform or refine the analysis of an image or further adjust a user-adjusted analysis.

The term “first artificial intelligence model” is used herein to mean a machine learning model or algorithm capable of analyzing and interpreting visual information from images. This artificial intelligence (AI) model may be a vision model, and may be used to generate initial analyses of images, extract features, and create element labels.

The term “second artificial intelligence model” is used herein to mean a generative machine learning model or algorithm capable of generating new content or data based on input information. In the context of this disclosure, this second AI model generates data such as textual descriptions based on the user-adjusted analysis of an image. The second AI model may be the same as the first AI model, or may be a different model.

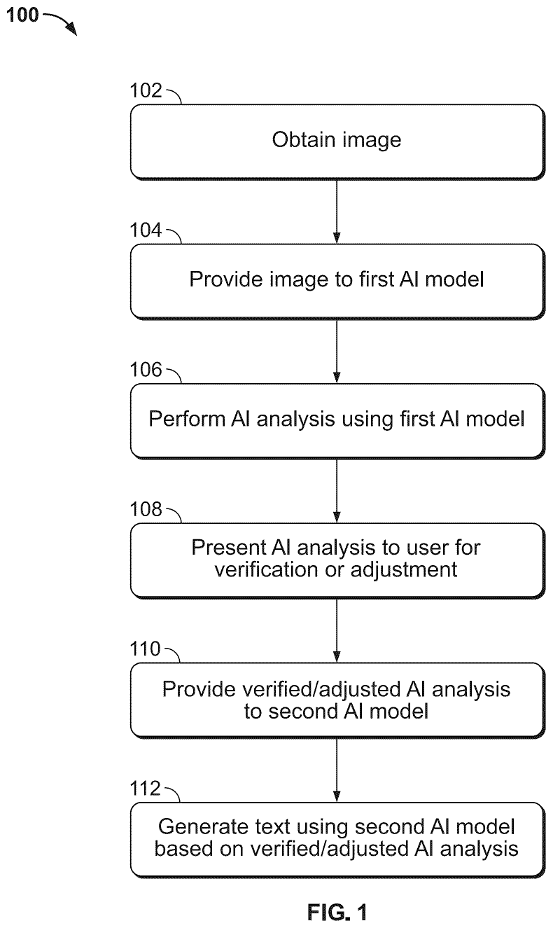

Referring now to FIG. 1, a method 100 for generating data using artificial intelligence based on image analysis is illustrated.

In some aspects, the method 100 may be performed by a computer system running an application. The application may be programmatic and may be installed on a client computing device within a computer system, such as a desktop computer, laptop, tablet, smartphone, or other suitable computing device. The application may be accessible via a network, and may be web-browser based. The application may provide a user interface on the client computing device that allows the user to interact with the various steps of the method 100 as explained in more detail below.

In some aspects, the method 100 begins with obtaining an image in step 102. The image may be obtained by the client computing device, which may be any suitable device capable of receiving, storing, and processing image data. The image may be obtained in various ways. For example, the image may be uploaded to the application from an existing file on the computing device, which may be in any suitable format such as JPEG, PNG, PDF, and the like. Alternatively, the image may be generated using generative AI, based on a set of instructions or some input text from a user to the application. The image may also be provided to the application from another location within the application.

In step 104, the obtained image is provided to a first artificial intelligence model (first AI model). The first AI model may be any suitable model capable of analyzing image data. In some cases, the first AI model may be a Language Learning Model (LLM) capable of taking both text and image data as input. The application, computing device, or computer system may handle image input and preprocessing, converting the image into a suitable format for the first AI model. This may involve resizing, normalizing pixel values, or encoding the image data. The system may support various types of first AI models. It may use a local model integrated directly into the application or interface with cloud-based AI services, sending preprocessed image data to remote servers for analysis. For LLMs capable of processing both text and image inputs, the application may package the image data along with relevant textual context, such as metadata, user-provided descriptions, or specific prompts for analysis. APIs or custom protocols may be used to communicate with the multimodal LLMs, ensuring efficient transmission of both image and text data.

In step 106, the first AI model analyzes the image to generate an AI analysis of the image. The first AI model may determine the subject of the image and what it is showing. For example, the first AI model may determine the elements of an invention depicted by the image, as well as how the invention works and functions. The application may facilitate this analysis process by managing the input of additional contextual information, such as user-provided text (e.g., an invention disclosure) or specific analysis parameters, to guide the AI's interpretation of the image. In cases where the first AI model is an LLM, the application may formulate appropriate prompts or queries to elicit the desired type of analysis. The first AI model then takes the image and any additional input information as an input, and outputs the AI analysis of the image.

In step 108, the AI analysis of the image is presented to a user of the application via a user interface. The analysis may be presented in any suitable manner, such as text on a display screen on a Graphical User Interface (GUI). The user may adjust the AI analysis according to their own understanding of the image and what it depicts. If the user does not wish to adjust or supplement the AI analysis, because for example, the AI analysis is already acceptable, the user may verify the AI analysis without adjustment. Verification may also occur after an adjustment to the AI analysis, and may be an explicit action (e.g. via the click of a button), or implicitly derived without a required action. The application may implement this presentation and interaction process through various mechanisms. The user interface may include an AI analysis module or interface within the application that may handle the rendering of the AI analysis in a user-friendly format. This module may support multiple presentation modes, such as plain text, structured outlines, or interactive diagrams. The module may incorporate text editing capabilities, enabling users to make direct modifications to the AI-generated analysis. This may include features like simple text editing, inline editing, and suggestion tracking. For users who prefer voice interaction, the application may integrate speech recognition technology, allowing for voice commands to be detected via a microphone of the computing device for making adjustments to the analysis.

The application may also implement a smart verification functionality that can detect when users have made significant changes to the analysis, prompting them to explicitly verify the modified content. In some cases, where adjustments are made, or where no changes are made, the system may use a time-based or interaction-based implicit verification mechanism, automatically considering the analysis as verified after a certain period of user inactivity or upon the user moving to the next step in the process or a different module within the application. The application may also implement a learning mechanism that tracks user adjustments over time, using this data to improve the initial AI analysis in future iterations. This adaptive system may lead to more accurate and relevant analyses tailored to individual user preferences or domain-specific requirements.

With continued reference to FIG. 1, in step 110, the adjusted or otherwise verified AI analysis is provided as an input to a second artificial intelligence model (second AI model). The second AI model may or may not be the same as the first AI model used in the previous steps. In particular, the AI analysis is provided to the second AI model as context for the purposes of generating data when requested to do so by the user. The data may be a textual description of the image that was analyzed, for example.

The method may support multiple types of AI models for data generation, including large language models (LLMs), specialized technical writing models, or domain-specific AI models. To enhance the quality of the generated data, the method may implement a context enrichment process. This could involve augmenting the AI analysis with additional relevant information, such as user-provided context (e.g. an invention disclosure document and/or text written into a document editor portion of the application), technical specifications, or data from connected knowledge bases. The application may use natural language processing techniques to identify key concepts in the analysis and automatically retrieve related information to provide a more comprehensive input to the second AI model.

The method may employ advanced prompting techniques to guide the second AI model in generating appropriate data. This could include dynamic prompt construction based on user preferences, document type, or specific writing requirements.

In step 112 shown in FIG. 1, the user uses a document editor to generate data and/or to request the second AI model to generate data. The data may include text. The document editor may be part of the user interface and may be a separate module to the AI analysis module used to review the AI analysis. The document editor may allow the user to input and edit text. The user may request the second AI model to generate data such as text by providing specific instructions or prompts in the application within the document editor. The second AI model may then be provided with the specific instructions or prompts as an input, and may then use this input in combination with the context provided by the adjusted AI analysis to generate data as an output. The generated text may thus be based on the user-adjusted AI analysis and any additional instructions and context provided by the user. The generated text may be presented to the user in the document editor for further review, adjustment, and approval. The document editor module may provide a rich text editing environment, supporting features such as formatting, version control, and collaborative editing. This document editor module may integrate with the AI data generation capabilities, allowing users to switch between manual writing and AI-assisted content creation.

To support user review and adjustment of generated text, the application may implement a diff-and-merge functionality, whereby AI-generated text is presented in the document editor module in a manner that distinguishes it from pre-existing text in the document editor module. This allows the user to easily compare AI-generated content with existing text, accept or reject specific changes proposed by the AI-generated content, and make edits. The application may include features for managing multiple versions of generated text, allowing users to explore different variations or iterations of AI-generated content. This could involve a branching system that enables users to compare different versions side-by-side and merge preferred elements from each.

In summary, the method 100 illustrated in FIG. 1 provides a comprehensive approach to generating data from images using artificial intelligence, with user interaction as a key component. This method may help to produce more accurate and contextually appropriate data generation using AI. The integration of user input may help to mitigate potential errors or misinterpretations by the AI models, leveraging human expertise and understanding. This method may be particularly useful in fields requiring precise image interpretation and detailed textual descriptions, such as technical documentation, patent drafting, or scientific research.

Whilst the proceeding description now focuses on this example of text generation using AI, it is to be understood that this is exemplary only, and the embodiments of this disclosure can also be used to generate other types of data in addition to or instead of text data.

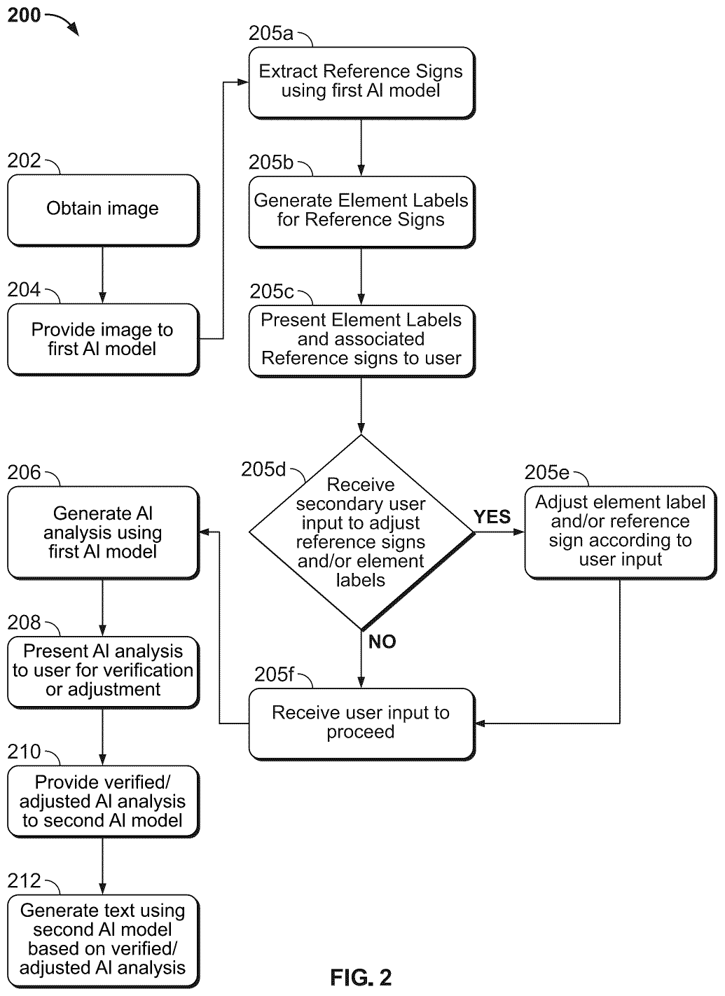

Referring now to FIG. 2, a more detailed process 200 is illustrated. This process 200 includes additional steps that further enhance the accuracy of the output generated by the second AI model. The first and second steps 202 and 204 of the process 200 are the same as steps 102 and 104 of the method 100 shown in FIG. 1, respectively. As such, in step 202, an image is obtained. In step 204, the obtained image is provided to a first AI model. However, the process 200 additionally includes steps 205a to 205f, which are designed to handle images with specific features such as reference signs. The additional steps (205a - 205f) will now be explained in more detail below.

Once the image is obtained and provided to the first AI model in step 204, in step 205a the first AI model extracts and recognizes specific features present in the image, and the elements to which they are associated. The specific features may be reference signs, numerical indicators, or the like. The specific features may be connected to an element of an image (such as a shape, part, subject, or portion within the image) via a lead-line, or may be overlaid on the element itself. In either case, the first AI model is configured to extract both the specific feature in the image and its associated element. For simplicity, the proceeding description refers to reference signs as a specific example of the feature of the image. However, it is to be understood that this is exemplary only, and other specific features may also or alternatively be recognized and extracted by the first AI model.

In step 205b, the first AI model uses the reference sign and its associated extracted/identified element to generate an element label for that specific element. This occurs for all detected reference signs, such that each element associated with a reference sign is given a generated element label.

In step 205c, the generated element labels and their associated reference signs are presented to the user. This may be implemented by an ‘element labels check’, such that a table of the reference signs and their associated element labels are provided via the user interface to the user. This may be provided via the AI analysis module of the user interface. Elements and their associated reference signs may be included in the same row within the table, to indicate their association. Optionally, an indication of the images (if there are multiple images) that the same reference sign is present in is also provided to the user for review. This step enables the user to effectively preview the AI analysis by getting a sense of what elements the first AI model has detected in the image and how the elements correspond to existing reference signs. In order to present the element labels and associated reference signs in a manner in which the user can interact with them on the user interface, the method may include presenting the reference signs (or features more generally) in an editable format. To do this, the method may include presenting editable references to the reference signs (or features) rather than the reference signs (or features) themselves. For example, if the image includes image data that displays the reference sign ‘104’, the presentation of the reference sign to the user may include a reference formed from text data (e.g. the numbers 1,0,4 in sequence) rather than the original image data. In this manner the user can easily edit the presented data (e.g. in text) rather than having to edit an image.

In step 205d, the user may interact with the presented element labels and associated reference signs to adjust them if required via a secondary user input to the user interface. For example, if some element label is incorrectly named or identified, the user can impart the secondary user input to modify that element label. In an example, element labels and reference signs may be presented in editable text boxes, such that the user can simply click or select an element text box or a reference sign text box to edit it as required within the table. Optionally, the user then has to verify or discard their changes using a save function, which may be implemented via a button in the user interface, to save or discard changes.

In step 205e, if the user chooses to amend the element labels or reference signs, the user can modify as many element labels or reference signs as is desired, to effectively change the names of elements identified by the first AI model, or modify their associated reference signs.

The intermediary step of allowing user adjustment of element labels and reference signs may play a beneficial role in enhancing the overall accuracy and quality of the AI output. By providing users with the opportunity to correct any misidentifications or inaccuracies in the element labels at this stage, the process 200 may effectively prevent these errors from propagating through subsequent steps of the analysis. This early intervention may significantly reduce the likelihood of misinterpretations in the final AI-generated data.

In some cases, the correction of element labels at this stage may have a cascading effect on the accuracy of the entire process. For instance, if the first AI model misidentifies a component in an image, correcting this error early on may prevent the generation of inaccurate or irrelevant textual descriptions later in the process. Furthermore, these user-provided corrections may serve as valuable additional context for the AI models, potentially improving their performance in subsequent analyses.

The inclusion of this user verification step may also contribute to the system's ability to learn and adapt over time. By tracking and analyzing the types of corrections users frequently make, the system may potentially refine its initial element identification processes, leading to improved accuracy in future analyses. This iterative improvement process may result in a more efficient and reliable system over time, reducing the need for extensive user interventions in later iterations.

Moreover, this step may allow for the incorporation of domain-specific knowledge that may not be readily apparent to the AI model. Users with expertise in particular fields may be able to provide nuanced labeling that captures subtle but important distinctions between elements, further enhancing the contextual understanding available to the AI for subsequent text generation.

If the user is already happy with the accuracy of the first AI model in generating appropriate reference signs, the process goes straight to step 205f from step 205d. Otherwise, the process goes from step 205d to step 205e. At step 205f, the user interface may receive user input to proceed. This may be via clicking a button or the like to proceed, such as a button labeled ‘generate analysis’or ‘generate descriptions’.

In step 205e, if the user chooses to amend the element labels or reference signs, the user can modify as many element labels or reference signs as is desired, to effectively change the names of elements identified by the first AI model, or modify their associated reference signs. In this manner, the user is able to interact with the process 200 to provide a secondary user input in addition to the primary user input to adjust the AI analysis, to effectively provide further context for the AI to use when generating text.

Upon selecting to proceed with the updated or verified element labels, the process returns to steps 206 to 212, which are identical to steps 106 to 112 (see FIG. 1) respectively. However, in steps 206, 208, 210 and 212 of the process 200, since the user has the opportunity to check and amend the reference sign element labels using a secondary user input, prior to the AI analysis of the images being generated, the AI analysis is performed on the basis of the image and the updated/verified element labels. This allows the first AI model to have the correct and accurate context of what elements are in the image, as approved by the user via the secondary user input, prior to going ahead with step 206. Ultimately, this provides the first AI model with more accurate context which helps to improve the AI analysis. The updated/verified element labels and reference signs may also be provided as context to the second AI model for the purposes of text generation, further improving the accuracy of the final output from the second AI model.

In the process 200, the user thus has two opportunities to provide user input—a secondary user input at step 205d and a primary user input at step 208, each of which can provide corrections to the first AI model's understanding of the content of a particular image or images. The ability to edit the element labels, reference signs and the AI analysis in the two steps 205d, 208 also provides a more transparent workflow for the user, allowing them to retain control and guide the first and second AI models through the process 200. The secondary user input and the method steps 205a to 205f may occur before and/or after the AI analysis has been generated in step 206. In this manner, the process 200 may be adapted to further enhance the accuracy of the output generated by the second AI model, by using the user-adjusted dataset to adjust the analysis of the image or to further adjust the user-adjusted analysis of the image. When being used to further adjust the user-adjusted analysis of the image, modifications via the secondary input to the dataset may automatically be applied to the user-adjusted analysis. For example, if the user modified a particular element label in the dataset, the corresponding element label may be automatically changed in the user-adjusted analysis without the need for further user input. In some cases, the user-adjusted dataset may be provided to the first AI model prior to generating the analysis of the image, such that the analysis of the image is based on the user-adjusted dataset.

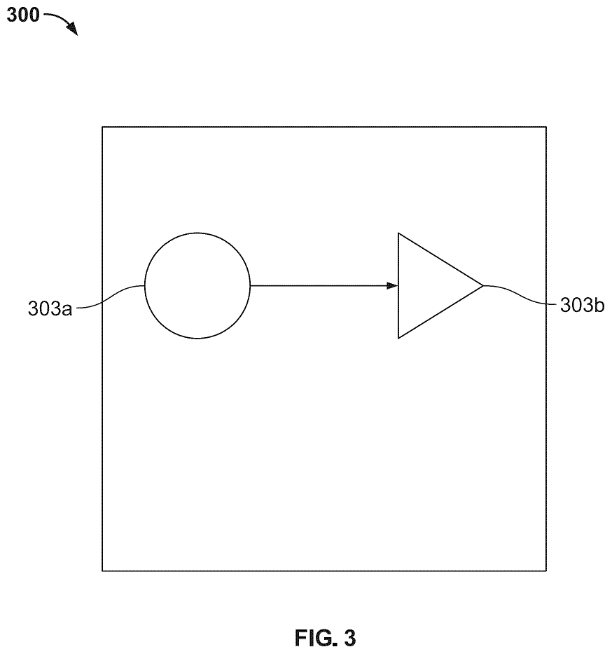

Referring to FIG. 3, an example image 300 is illustrated. The image 300 may be one of the types of images that the method 100 (see FIG. 1) or process 200 (see FIG. 2) can analyze. The image 300 includes a first image element 303a and a second image element 303b. The first image element 303a and the second image element 303b are represented by basic geometric shapes, specifically a circle and a triangle, respectively. An arrow connects the first image element 303a to the second image element 303b, indicating a relationship or flow between the elements 303a and 303b.

In some aspects, the first image element 303a and the second image element 303b may represent different components or elements of an invention or system. The arrow connecting the elements 303a, 303b may represent a functional relationship, interaction, or sequence between the components or elements 303a, 303b. For instance, the first image element 303a may represent an input or source component, while the second image element 303b may represent an output or target component. The arrow may then represent a process, operation, or transformation that occurs from the input to the output.

In some cases, the image 300 may be a diagram, schematic, or other graphical representation used in technical documentation or patent applications. The image 300 may depict an invention, a system, a process, or any other subject matter that can be represented visually. The image 300 may be a simplified or abstract representation, focusing on the key or elements and their relationships, rather than providing detailed or realistic depictions.

The image 300 may take various forms depending on the nature of the subject matter being represented and the context in which it is used. For example, the image 300 may be a line drawing, which is commonly used in patent applications to clearly illustrate the structure and relationships of different components. Line drawings may range from simple sketches to more detailed technical illustrations, providing a clear and unambiguous representation of an invention or system.

In some cases, the image 300 may be a photograph, which can be particularly useful for depicting real-world implementations of an invention or for showing the actual appearance of a product or device. Photographs may be used to illustrate physical characteristics, textures, or materials that are difficult to convey through other types of illustrations. The image 300 may also be a hand-drawn diagram, which can be useful for quickly capturing and communicating ideas during the early stages of invention or design. Hand-drawn diagrams may have a more informal appearance but can effectively convey the essential concepts and relationships between different elements. In other instances, the image 300 may be a computer-generated graphic or 3D rendering. These types of images can provide highly detailed and precise representations of complex systems or structures, allowing for accurate visualization of intricate components and their interactions. The image 300 may also take the form of a flowchart, block diagram, or other schematic representation, which can be particularly effective for illustrating processes, algorithms, or the logical flow of information within a system. These types of images may use standardized symbols and notations to represent different steps, decision points, or data flows.

The image 300 may be provided to the method 100 (see FIG. 1) or process 200 (see FIG. 2) for analysis. The first AI model may analyze the image 300, identifying the first image element 303a and the second image element 303b, and interpreting the relationship or flow indicated by the arrow. The first AI model may generate an initial analysis of the image 300, which may then be presented to the user for review and adjustment. The user-adjusted analysis may then be used as input to the second AI model for generating data, such as textual descriptions of the image 300.

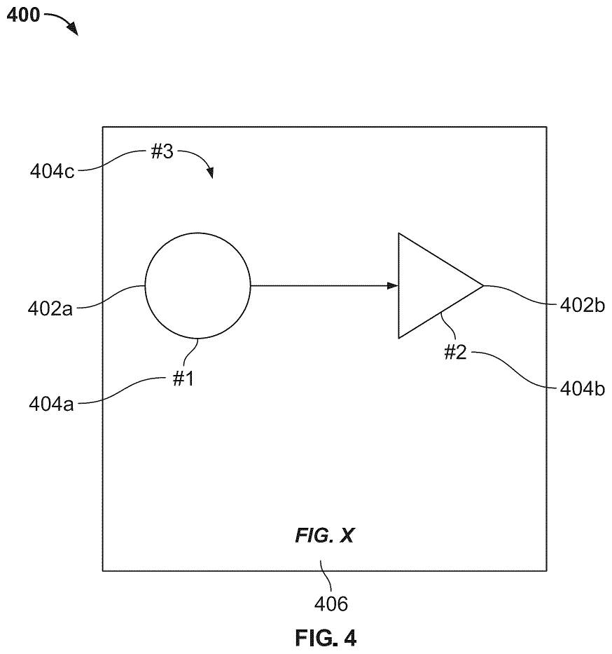

Referring to FIG. 4, an example image 400 is illustrated. The image 400 is similar to the image 300 shown in FIG. 3, but with the addition of reference signs. The reference signs may be used in patent drawings or other technical diagrams to identify specific elements. In the image 400 in FIG. 4, a first image element 402a and a second image element 402b are provided with a first image element reference sign 404a and a second image element reference sign 404b respectively. A third reference sign 404c designates the image 400 as a whole. The image 400 also includes a figure identifier 406, labeled as “FIG. X” within the rectangular frame.

In some aspects, the first image element 402a and the second image element 402b in FIG. 4 may represent different components or elements of an invention or system, similar to the first image element 303a and the second image element 303b in FIG. 3. The reference signs 404a, 404b, and 404c in FIG. 4 may be used to label the elements 303a and 303b, providing a clear and unambiguous way to refer to specific parts of the image 400. The reference signs may be any suitable symbols, numbers, or letters that can be easily distinguished and recognized.

In some cases, the reference signs 404a, 404b, 404c may be connected to the elements 402a, 402b they label via lead-lines, or they may be overlaid directly on the elements 402a, 402b. The use of reference signs can be particularly beneficial in complex diagrams or images with many elements, as it allows for precise identification and description of each element. In some aspects, the image 400 may be any image type, such as those described with reference to FIG. 3.

In the process 200 illustrated in FIG. 2, the first AI model may extract and recognize the reference signs 404a, 404b, 404c present in the image 400 from FIG. 4, and the elements 402a, 402b to which they are associated. This may occur in step 205a shown in FIG. 2, where the first AI model extracts and recognizes the reference signs and their associated elements. The first AI model may then generate element labels associated with the elements 402a, 402b in step 205b. The element labels and their associated reference signs 404a, 404b, 404c may be presented to the user in step 205c, allowing the user to review and adjust them as needed in step 205d via a secondary user input. This additional layer of user interaction may provide a more accurate context for the AI models, leading to more precise and contextually appropriate data generation.

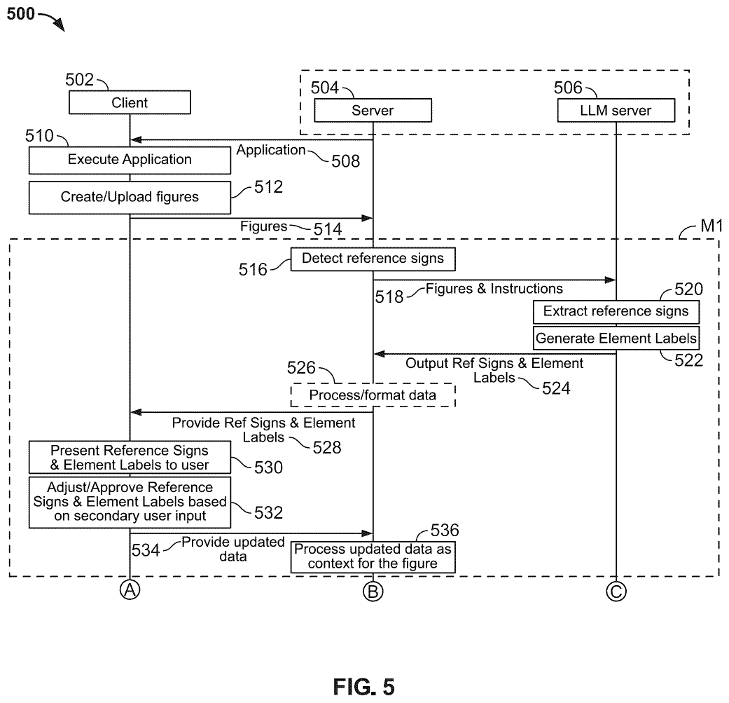

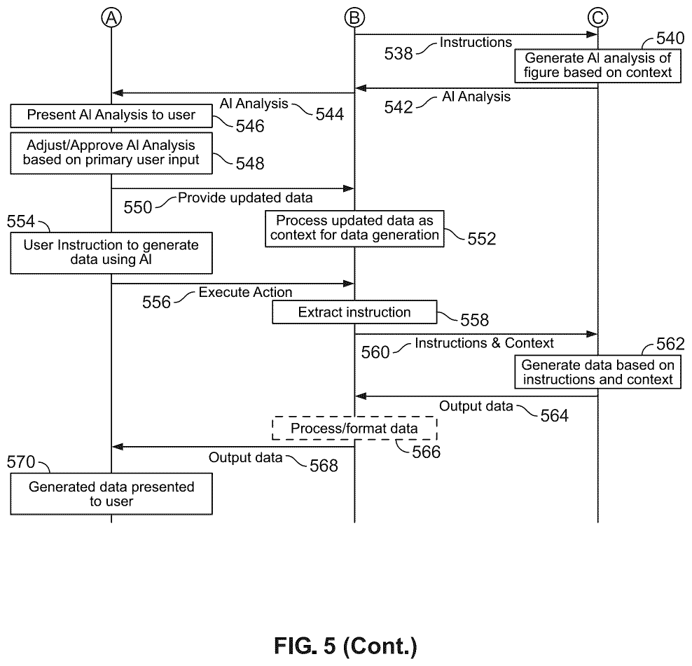

Referring now to FIG. 5, a sequence diagram 500 is illustrated, showing an exemplary implementation of the methods 100 and 200 as described above with reference to FIGS. 1 and 2. In this example, the computer system responsible for performing the methods includes a client 502, a server 504, and an LLM server 506. The server 504 and the LLM server 506 may be separate or form part of the same server. However, it is to be understood that the methods may be implemented using various configurations of computing systems. In some aspects, the method may be performed entirely on a single client device, such as a personal computer or mobile device, without the need for external servers. Alternatively, the method may utilize a client-server architecture, where the client device communicates with a server to perform certain computationally intensive tasks. In other implementations, the method may employ a distributed system architecture, involving multiple servers, including specialized LLM servers for handling complex language processing tasks. Some configurations may use a hybrid approach, where certain steps are performed locally on the client device, while others are offloaded to one or more remote servers based on factors such as processing requirements, data privacy considerations, or network conditions. The sequence diagram 500 provides a visual representation of the method 100 (see FIG. 1) or the second method 200 (see FIG. 2), wherein the additional steps of the second method 200 are designated by bounding box M1 that is illustrated in FIG. 5. The sequence diagram 500 details the flow of data and instructions between the client 502, the server 504, and the LLM server 506.

In some aspects, the client 502 may be a computing device, such as a desktop computer, laptop, tablet, smartphone, or other suitable computing device. The server 504 may be a computing device or a network of computing devices that host the application. The LLM server 506 may be a computing device or a network of computing devices that hosts the first AI model and the second AI model. The AI models (i.e. the first AI model and the second AI model) may each be LLMs and may be the same model or different models.

Continuing to refer to FIG. 5, the server 504 may push the application at step 508 to the client 502, via a web-browser for example. The application may be the application implementing the method 100 (see FIG. 1) or the second method 200 (see FIG. 2). The client may then execute the application at step 510. The client 502 may create or upload an image or images in the application at a next step 512, including images for analysis. The images may then be sent to the server 504 at step 514.

The process either then continues with the steps bounded by box M1 in FIG. 5, indicating that the process follows the method 200 as described with reference to FIG. 2, or the process continues to step 538 whereby instructions are provided to the LLM server 506 to generate the AI analysis of the images. This decision may be made automatically by the server 504 in step 516, wherein the server 504 detects the presence of reference signs in the images, and then sends the images and instructions to the LLM server 506 in step 518 to extract the reference signs from the images. In other words, when the server 504 receives the images, it may detect reference signs in the images at step 516, and continue with the steps within the bounding box M1. However, if no reference signs are detected in step 516, the process may continue to step 538. It is to be understood that the process of detecting reference signs may be performed via any suitable image or feature recognition process, and may alternatively be performed by the first AI model at the LLM server 506.

Continuing with the process illustrated in FIG. 5, in the event that reference signs are detected in step 516, the LLM server 506 may extract reference signs from the images at step 520 using the first AI model and generate element labels associated with those reference signs at step 522.

In some aspects, and as discussed previously, the reference signs 404a, 404b, 404c may be considered as ‘features’ of the image itself that serve as visual identifiers for specific elements within an image. The reference signs 404a, 404b, 404c can be various forms of features, such as numbers, letters, or symbols, and may be strategically placed to highlight particular components or aspects of a diagram, drawing, or illustration. For example, a reference sign may be used to indicate a key part of an invention, such as a gear in a mechanical system or a circuit component in an electronic device. The reference signs 404a, 404b, 404c may be connected to their corresponding elements via lead lines or may be directly overlaid on the elements themselves. By utilizing reference signs, complex images can be broken down into clearly identifiable elements, allowing for more precise and unambiguous descriptions of each component. This approach may enhance the clarity and effectiveness of technical documentation, particularly in fields where detailed visual representations are useful for conveying information accurately.

Continuing to refer to FIG. 5, the generated element labels and their associated reference signs may be sent back to the server 504 at step 524. The server 504 may optionally process and format this data in a step 526 before providing the reference signs and element labels at step 528 to the client 502. The format of the data is such that the element labels are associated with their corresponding reference signs in a dataset, that maintains the association. This can be in the form of a table, such as a look-up table, but can also be implemented using metadata or identifiers as will be understood.

The client 502 may then present the reference signs 404a, 404b, 404c and element labels in the dataset to the user at step 530. The dataset may be provided via the AI analysis module of the user interface described previously. The dataset presented to the user provides an indication of the association of an element label to a particular reference sign. This indication may be provided by, for example, showing the dataset in a tabular format, where an element label is in the same row as its associated reference sign. The user interface may allow for adjustment or approval of the dataset based on the secondary user input at step 532. This may include edits to the reference sign, the element label, or both, to form a user-adjusted dataset. The updated data in the user-adjusted dataset is sent back to the server 504 in step 534, which processes it as context for the specific image or images to which it relates in step 536. At this point in the process, the steps within the bounding box M1 have been completed, and the process returns to the steps shared by both methods 100 and 200 with reference to FIGS. 1 and 2 respectively.

Continuing to refer to FIG. 5, the server 504 then sends instructions to the LLM server 506 at step 538, which generates an AI analysis of the image based on the provided context at step 540. If the steps in bounding box M1 are followed, the context sent to the LLM server 506 for use in generating the AI analysis using the first AI model may include the user-adjusted dataset or data therefrom, including the adjusted/verified element labels and their associated adjusted/verified reference signs. The context may further include various elements to enhance the accuracy and relevance of the generated analysis. It may comprise the image itself, and any previous AI analyses that have been verified or adjusted by the user. Additionally, the context may include metadata about the image, such as its file type, resolution, or creation date, as well as any relevant information from the document or application where the image is being used, such as an invention disclosure document or text already written into the document editor module of the application. In some cases, the context may also encompass broader project-specific information or domain knowledge that could aid in interpreting the image more accurately within its intended context.

Once the AI analysis is generated by the first AI model at the LLM server at step 540, this AI analysis is sent back to the server 504 at step 542 and then to the client 502 at step 544. Optionally, the server 504 processes the AI analysis to ensure it is in the correct format for presentation to the user at the client 502.

The client 502 then presents the AI analysis to the user at step 546. The AI analysis may be presented to the user through the user interface on the client device, in the AI analysis module. This interface may display the analyzed image alongside generated AI analysis text. The AI analysis may be presented in an editable format, allowing the user to enter the primary user input to make direct modifications or annotations to the text of the AI analysis. The user interface may include options for the user to approve, reject, or suggest changes to specific parts of the analysis. The user interface may provide interactive elements, such as dropdown menus or checkboxes, allowing users to easily select and modify specific aspects of the analysis. In some cases, the system may present multiple alternative interpretations or descriptions for certain elements, enabling users to choose the most appropriate option.

Continuing to refer to FIG. 5, at step 548 the client 502 receives the primary user input for adjustment or approval of the AI analysis. The primary user input may be provided to the user interface on the client device, via any suitable user input device, such as a touchscreen, mouse, and/or keyboard. The primary user input may modify the AI-generated analysis of the image. The user interface may provide various tools and options for the user to interact with the analysis, such as text editing capabilities. The user has the ability to accept, reject, or refine specific portions of the analysis, ensuring that the final output accurately reflects their understanding and intent. In some cases, the system may offer alternative interpretations or descriptions, allowing the user to select the most appropriate one.

Once the primary user input is recorded, at step 550 updated data corresponding to the adjusted and/or verified (e.g. accepted) AI analysis is sent to the server 504, which processes it as context for data generation in step 552. The user may then provide, via the user interface of the application at the client 502, instructions to generate data such as text using generative AI at step 554. In some aspects, the user may request AI-generated data through various methods within the application user interface. The user may interact with a dedicated AI generation button or menu option, which could trigger a prompt for specific instructions or parameters for the desired output. Alternatively, the application may provide a text input field where users can type natural language requests for AI-generated content. In some implementations, the user may be able to highlight existing text or elements within the document and request AI-generated expansions, revisions, or related content. The application may also offer pre-defined templates or categories of AI-generated content that users can select from, such as “Generate Technical Description” or “Create Summary.” In some cases, the user may be able to adjust AI generation settings, such as output length, style, or level of detail, before submitting their request. The system may also support voice commands, allowing users to verbally request AI-generated data through a microphone-enabled device for example. The instructions are sent to the server 504 as an action to execute at step 556. The server 504 extracts the instructions at step 558 and forwards them along with any required context to the LLM server at step 560. The context may alternatively be provided to the LLM server 506 prior to this step. The context includes the adjusted and/or verified AI analysis.

The LLM server 506 then utilizes the second AI model, for example an LLM, to generate the data based on the instructions and context provided to it at step 562. The LLM server 506 then sends the output generated data back to the server 504 at step 564. The server 504 optionally processes and formats this data at step 566 before sending the formatted output data to the client at 568. If the data is text data, the generated text is presented to the user via the user interface of the application at step 570.

The sequence diagram in FIG. 5 therefore shows how the methods 100 and 200 as described in FIGS. 1 and 2 may be performed in a distributed computing environment. The illustrated process shows the steps in bounding box M1, which represent the method steps 205a to 205f in FIG. 2. The steps 205a-205f are thus performed when performing the second method 200 but not the method 100 shown in FIG. 1. The detection of reference signs in the image at the server 504 shown in FIG. 5 (or at the LLM server 506) may function as a trigger to determine when to run the method 100 or the second method 200 with reference to FIGS. 1 and 2. If reference signs are detected, the second method 200 is run. If reference signs are not detected, the method 100 is run (without the steps in bounding box M1). Alternatively, the method 100 or 200 may be manually selected.

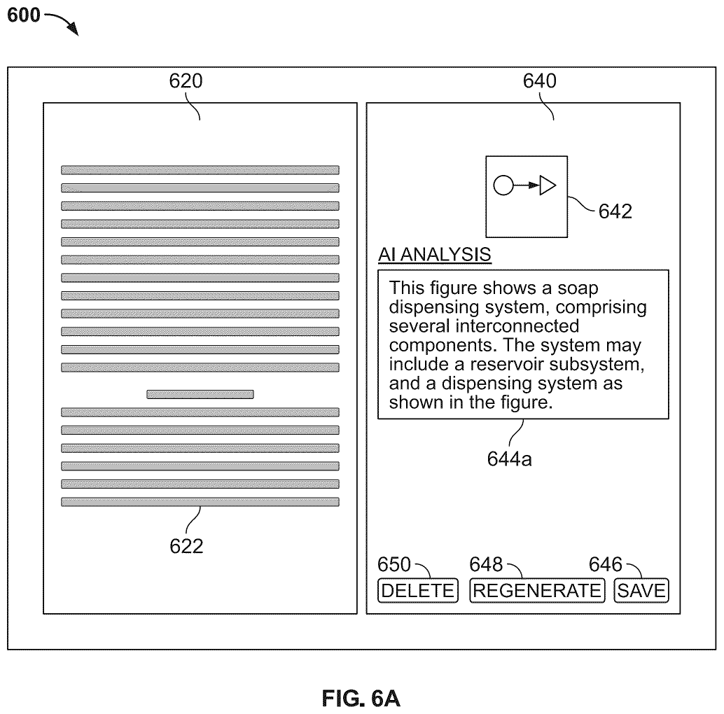

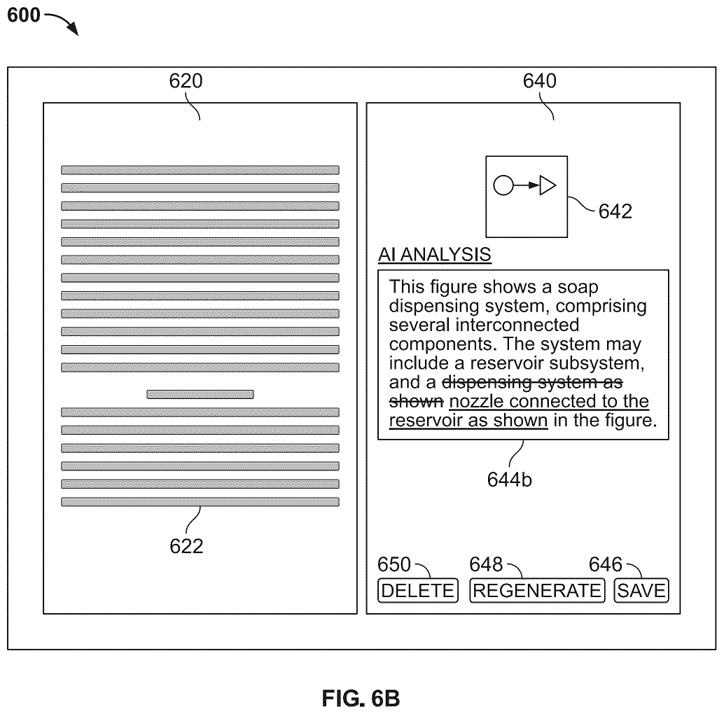

Referring to FIG. 6A, an exemplary layout of a user interface 600 of the application is illustrated. The user interface 600 is divided into two main sections: a document editor 620 on the left and an AI analysis module 640 on the right.

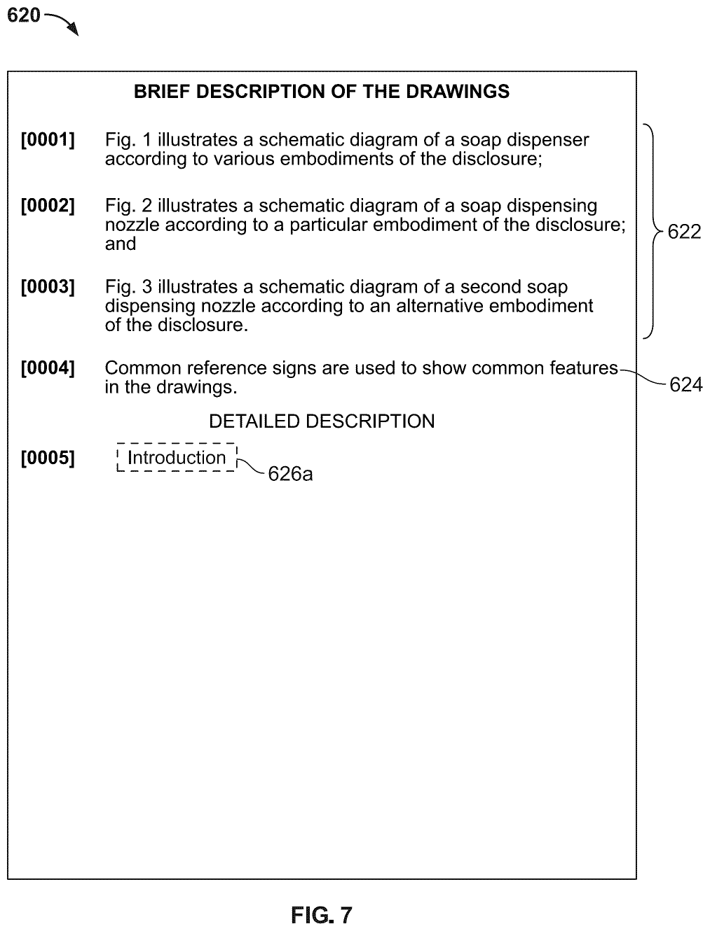

The document editor 620 may be a text editing area where the user can write text and/or request the second AI model to generate text. The document editor 620 may include a text 622, which may be the result of AI input or user input. The text 622 may be presented in any suitable manner, such as lines of text on a display screen. The document editor may also include a free-formed text 624 (see FIG. 7) that may be directly written into the editor by the user. The document editor 620 may allow the user to freely add, edit, or delete text, providing a flexible workspace for creating and refining a document.

The AI analysis module 640 on the right side of the user interface 600 is used to present the AI analysis of images and allow user input to edit the analysis and save it accordingly. At the top of the AI analysis module 640 is an image 642, representing a simplified or miniaturized version of the image being analyzed. Below the image 642 is a box labeled “AI ANALYSIS” 644a containing text. This text represents an exemplary AI analysis of the image 642 provided to the user for adjustment or verification.

At the bottom of the AI analysis module 640, there are three buttons: a first button 646 labeled “SAVE,” a second button 648 labeled “REGENERATE,” and a third button 650 labeled “DELETE.” The buttons 646, 648, 650 may allow user interaction with the AI analysis. For example, pressing the first button 646 saves the user edits to the AI analysis in box 644a. The second button 648 forces the AI to regenerate an AI analysis for the image, which can be useful if the image needs to be edited as the user can then regenerate the AI analysis after the image edits. The third button 650 may allow the user to delete the current AI analysis or the image and start over.

The layout of the user interface 600 demonstrates the integration of AI-generated content and user interaction in the process of analyzing images and creating data therefrom. The user interface 600 provides a visual and interactive platform for users to review and adjust the element labels and reference signs, adjust the AI analysis of images, verify the analysis, and generate text based on the verified analysis. This interactive process allows a user to maintain control over the AI analysis and text generation process, ensuring that the generated descriptions accurately reflect their understanding of the images.

The user interface may accommodate various types of user inputs to enhance flexibility and accessibility. In some aspects, the interface may support traditional input methods such as keyboard typing and mouse clicks, as well as touch-based interactions for devices with touchscreens. The system may also incorporate voice recognition capabilities, allowing users to provide verbal commands or dictate text. Gesture-based inputs may be supported on devices with appropriate sensors, enabling users to interact with the interface through hand movements or gestures. The user interface may be designed to be responsive, adapting to different screen sizes and orientations, from large desktop monitors to compact mobile devices. In some aspects, the user interface 600 may provide additional tools or features to assist the user in adjusting the AI analysis. For example, the user interface 600 may provide text editing tools, such as cut, copy, paste, undo, redo, find, replace, and spell check functions. The user interface 600 may also provide navigation tools, such as scroll bars, zoom controls, and page up, page down.

Referring to FIG. 6B, the user interface 600 is shown again, with modifications to the AI analysis in the AI analysis module 640. An editable text area, labeled “AI ANALYSIS” 644b, includes user inputted adjustments to the AI analysis of the image 642 via the primary user input. The user inputted adjustments are indicated in strikethrough and underline portions of text. In some aspects, the user interface may employ visual cues to highlight changes made to the AI analysis. For example, strikethrough text may be used to indicate deletions or modifications, while underlined text may represent additions or replacements. The visual cues may be presented in different colors to further distinguish between types of changes. It should be noted that the visual cues are for illustrative purposes only and may not reflect the final state of the text. The system may provide options to toggle the visibility of the visual cues that highlight changes, allowing users to view the clean, final version of the text or the marked-up version showing all modifications. This feature may enhance the user's ability to track and review changes made to the AI-generated analysis, facilitating a more transparent and collaborative editing process. Alternatively, the editable text area 644b may not provide visual indicators of edits. The transition from FIG. 6A to FIG. 6B demonstrates the capability of the user interface 600 to receive a primary user input adjusting the analysis of the image to form a user-adjusted analysis.

Referring to FIG. 7, the document editor 620 of the user interface 600 (see FIGS. 6A and 6B) is illustrated. The document editor 620 is a text editing area where the user can write text and/or request the second AI model to generate text. For example, the document editor 620 may serve as the primary workspace for drafting a patent application. In some cases, the document editor 620 may provide a structured environment tailored for patent application drafting, including sections for various parts of the application such as the background, summary, detailed description, and claims. The document editor 620 may allow users to seamlessly integrate AI-generated content with manually written text, enabling efficient creation of comprehensive patent applications. In some aspects, the document editor 620 may include features specifically designed to support patent drafting, such as automatic numbering of claims, cross-referencing tools, auto-editing and revising of element labels or reference numerals, and the ability to insert and label figures.

The document editor 620 may include the text 622, which may be the result of AI input or user input. The text 622 may be presented in any suitable manner, such as lines of text on a display screen. The document editor 620 may also include the free-formed text 624 that the user has directly written into the document editor 620. The document editor 620 may allow the user to freely add, edit, or delete text, providing a flexible workspace for creating and refining a document.

In some aspects, the document editor 620 is a module of the user interface within the application that allows the user to input and edit text. The user may request the second AI model to generate text by providing specific instructions or prompts in the application within the document editor module. The generated text may be based on the user-adjusted AI analysis and any additional context provided by the user. The generated text may be presented to the user in the document editor for further review, adjustment, and approval.

In some cases, the document editor 620 may include an AI section placeholder 626a. The AI section placeholder 626a may be a designated area within the document editor 620 where the user can request the second AI model to generate text. The user may activate the AI section placeholder 626a, for example, by clicking on it. Upon activation, the AI section placeholder 626a may call on the second AI model to draft a section corresponding to that the AI section placeholder 626a. The second AI model may then draft the section accordingly, using the user-adjusted AI analysis and any additional context provided by the user or the application.

In some aspects, the document editor 620 may allow the user to provide additional instructions to the second AI model. The additional instructions may be provided in various ways, such as through a menu, a chat function, or directly in the document editor 620. The additional instructions may guide the second AI model in generating text that is tailored to the user's specific needs or preferences.

In some cases, the document editor 620 may allow the user to input other pre-existing data. This pre-existing data may be any suitable data that provides additional context for the second AI model. For example, the pre-existing data may include text already written into the document editor 620, an invention disclosure document, or any other relevant information. The pre-existing data may be used by the second AI model in conjunction with the user-adjusted AI analysis to generate text.

In some aspects, the document editor 620 may provide various tools and features to assist the user in writing text and interacting with the second AI model. For example, the document editor 620 may provide text editing tools, such as cut, copy, paste, undo, redo, find, replace, and spell check functions. The document editor 620 may also provide navigation tools, such as scroll bars, zoom controls, and page up, page down. The document editor 620 may further provide features for managing multiple versions of the document, allowing users to explore different variations or iterations of the document.

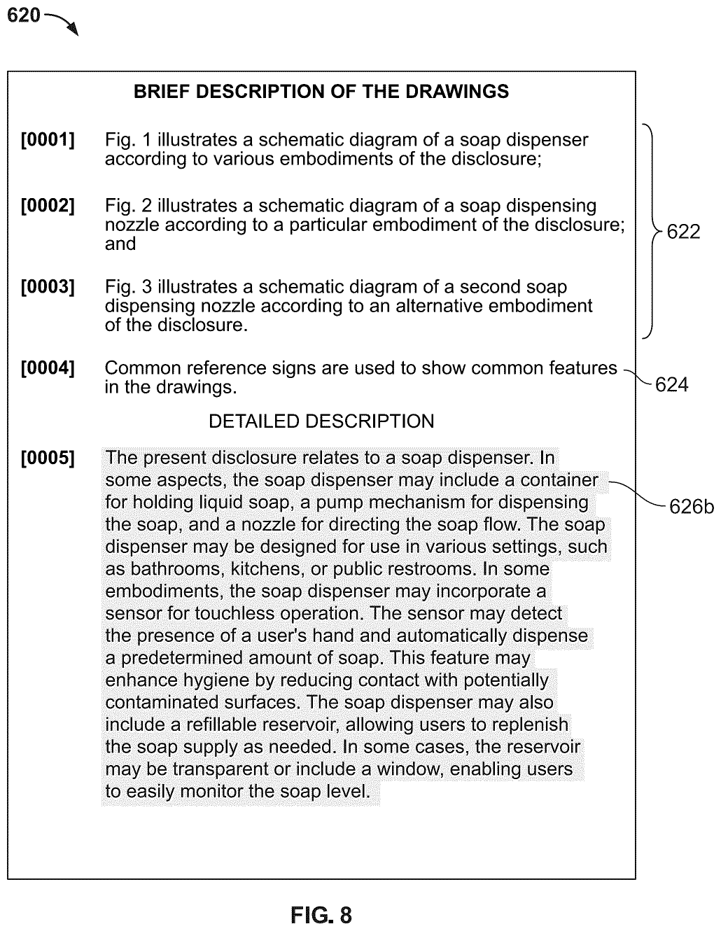

Referring to FIG. 8, the document editor 620 is shown again, but this time with an AI generated text 626b replacing the AI section placeholder 626a (see FIG. 7). The AI generated text 626b is the result of the second AI model generating text based on the user-adjusted AI analysis and any additional context provided by the user or the application. The AI generated text 626b is presented to the user in the document editor 620 for further review, adjustment, and approval. The transition from FIG. 7 to FIG. 8 demonstrates the capability of the user interface 600 to receive a primary user input adjusting the analysis of the image to form a user-adjusted analysis, and then to generate text based on the user-adjusted analysis.

In some aspects, the user can call on the second AI model sequentially or iteratively to build up a description in the document editor 620 shown in FIG. 8. For example, the user may first request the second AI model to generate a general overview of the image, then request more detailed descriptions of specific features or elements in the image. The user may also request the second AI model to generate different versions of the description, allowing the user to compare and choose the most suitable version. The user may also adjust the AI generated text 626b as needed, and then request the second AI model to generate additional text based on the adjusted the AI generated text 626b. This iterative process allows the user to gradually build up a comprehensive and accurate description of the image, while maintaining control over the content and style of the description.

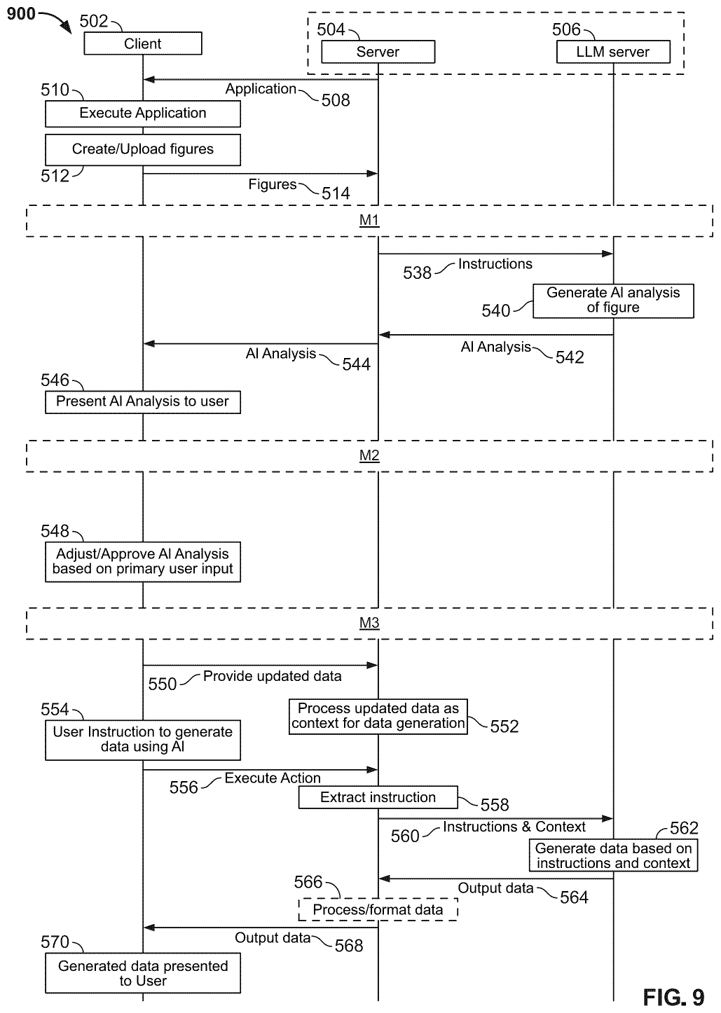

Referring to FIG. 9, a sequence diagram 900 illustrates various alternative interactions between the methods 100 and 200 described above with reference to FIGS. 1 and 2. The steps illustrated in FIG. 9 are the same as those illustrated in FIG. 5. The bounding box M1 of FIG. 5 has been simplified to the box M1 in FIG. 9, but it should be understood to include the same steps.

FIG. 9 shows that the steps bound by the box M1 in FIG. 5, which represent the method steps 205a to 205f shown in FIG. 2, can be performed at different positions in the process. Specifically, the steps bound by the box M1 can be performed at any combination of box positions M1, M2, and M3. This flexibility allows for the adjustment of the AI analysis based on modifications to the reference signs and/or element labels at various stages of the process. When performed at box position M1, the adjustments occur before the AI analysis is created, allowing the initial analysis to incorporate the user-verified reference signs and element labels. If executed at box position M2, the adjustments take place after the AI analysis is created but before user modification, enabling a refinement of the analysis based on updated reference information. When implemented at box position M3, the adjustments are made after the user has already modified the AI analysis, providing an opportunity for further refinement based on the most up-to-date reference sign and element label information. The system may also support any combination of the box positions M1, M2, M3, allowing for multiple adjustment points throughout the process to ensure accuracy and relevance of the final AI analysis.

In this way, the sequence diagram 500 illustrates how the methods 100 from FIGS. 1 and 200 from FIG. 2 can be implemented in a distributed computing environment, with the flexibility to adjust the AI analysis at different stages of the process based on the presence of reference signs in the images. This flexibility allows for a more accurate and contextually appropriate generation of text based on the AI analysis.

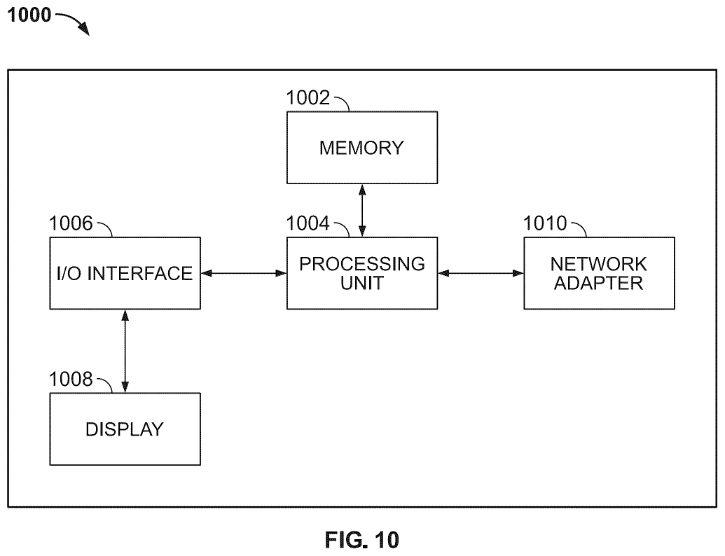

Referring to FIG. 10, an exemplary computing device 1000 is illustrated. The computing device 1000 may be suitable for executing the application that implements the method 100 or 200 as described with reference to FIGS. 1 and 2. The computing device 1000 may be any suitable device capable of receiving, storing, and processing image data. In some aspects, the computing device 1000 may be a desktop computer, laptop, tablet, smartphone, or other suitable computing device. The computing device 1000 may include a memory 1002 and a processor 1004 storing instructions. The processor 1004 may be any suitable type of processor for processing computer executable instructions to control the operation of the computing device 1000. The memory 1002 may be any suitable type of memory for storing computer executable instructions, data structures, program modules, or other data.

The computing device 1000 may also include an I/O interface 1006, a display 1008, and a network adapter 1010. The I/O interface 1006 may be any suitable interface for receiving input from a user and providing output to the user. The display 1008 may be any suitable type of display for presenting information to the user, such as a liquid crystal display (LCD), a light emitting diode (LED) display, or an organic light emitting diode (OLED) display. The network adapter 1010 may be any suitable type of network adapter for connecting the computing device 1000 to a network, such as a local area network (LAN), a wide area network (WAN), or the Internet.

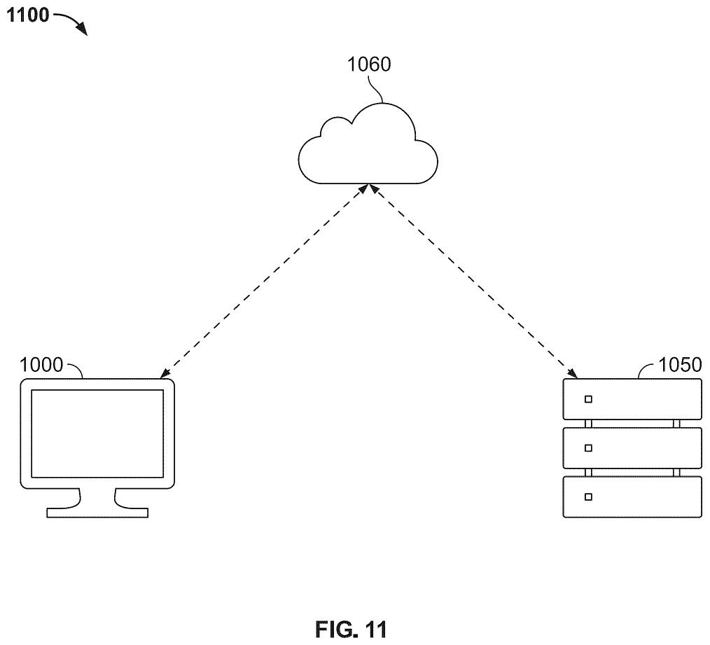

Referring to FIG. 11, an exemplary distributed system 1100 is illustrated. The system can be implemented as a distributed system with a network connecting a computing device 1000 and server(s) 1050. The computing device may be any computing device described previously. The server(s) 1050 may be a computing device or a network of computing devices that host the application implementing the method 100 (see FIG. 1) or the second method 200 (see FIG. 2). The servers 1050 and the computing device 1000 may be connected via a network 1060, which may be a local area network (LAN), a wide area network (WAN), or the Internet.

In some aspects, the distributed system 1100 may employ cloud computing technologies, allowing for scalable and flexible resource allocation. The system may utilize load balancing techniques to distribute workloads across multiple servers, ensuring performance and reliability. Additionally, the distributed system 1100 may implement redundancy and failover mechanisms to maintain system availability in case of hardware failures or network issues. The system may also incorporate edge computing capabilities, allowing certain processing tasks to be performed closer to the data source or end-user, reducing latency and improving response times. Furthermore, the distributed system 1100 may employ containerization and microservices architectures, enabling modular deployment and easier maintenance of different components of the application implementing the methods 100 or 200 shown in FIGS. 1 and 2 respectively.

In some aspects, the distributed system 1100 illustrated in FIG. 11 may be used to implement the processes described with respect to FIGS. 5 and 9. The computing device 1000 may serve as the client device, executing the application and providing the user interface for interaction. The servers 1050 may host the server-side components, including the first and second AI models, and handle the processing of images, generation of AI analyses, and text generation. The network 1060 may facilitate the communication between the computing device 1000 and the servers 1050, enabling the exchange of data such as images, AI analyses, user inputs, and generated text. This distributed architecture may allow for efficient processing of complex AI tasks on powerful server hardware while maintaining a responsive user interface on the client device. The system may also scale to accommodate multiple users and handle varying workloads by distributing tasks across multiple servers as needed.

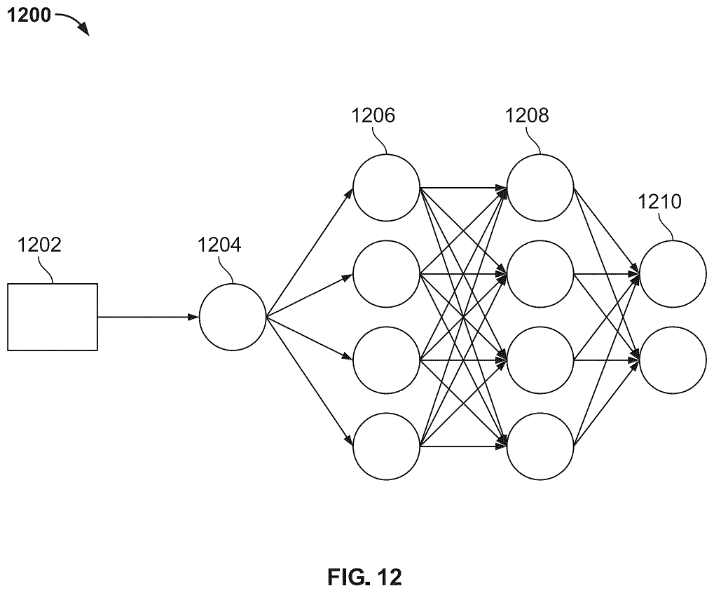

Referring to FIG. 12, an exemplary AI model 1200 is illustrated. This exemplary AI model 1200 may correspond to the first and/or second AI models. The AI model 1200 represents a neural network architecture that may be used as the first AI model or the second AI model in the methods 100 and 200 shown in FIGS. 1 and 2 respectively. The AI model 1200 comprises several interconnected components that process information in a sequential manner.

In some aspects, the AI model 1200 may have a transformer network architecture. Transformer network architectures are a type of model architecture used in the field of machine learning, particularly in the area of natural language processing. Transformer architectures are known for their ability to handle sequential data, making them well-suited for tasks such as text generation and image analysis. However, it should be noted that the AI model 1200 is not limited to transformer network architectures and may be implemented using any suitable model architecture capable of analyzing image data and/or generating text.

The AI model 1200 begins with context data 1202, which is provided as input to the model. The context data 1202 may include the user-adjusted AI analysis of an image, as well as any additional context provided by the user or the application. The context data 1202 may be processed by the AI model 1200 to generate data, such as textual descriptions of the image. It should be understood that the context data 1202 may not be connected to an input layer 1204 in the manner illustrated, rather, this is merely for visualization purposes. Other inputs may provided to the AI model 1200.

The AI model 1200 has the input layer 1204. The input layer 1204 serves as the entry point for information into the neural network. The input layer 1204 may receive the context data 1202 and transform it into a format suitable for processing by the subsequent layers of the AI model 1200.

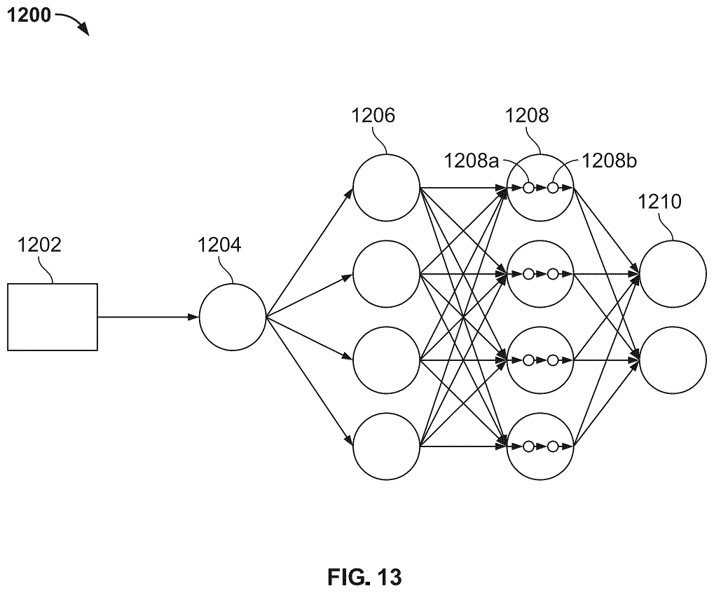

Following the input layer 1204 is a first hidden layer 1206. This layer consists of multiple nodes, each connected to the input layer 1204. The first hidden layer 1206 processes the information received from the input layer 1204 and passes it on to the next layer of the AI model 1200. The first hidden layer 1206 is fully connected to a second hidden layer 1208, which also comprises multiple nodes. The second hidden layer 1208 processes the information received from the first hidden layer 1206 and passes it on to the next layer of the AI model 1200. The second hidden layer 1208 may include multiple sub-layers, such as hidden layer 1208a and hidden layer 1208b (see FIG. 13), each performing different transformations on the input data.

The final component of the AI model 1200 is an output layer 1210. The output layer 1210 receives the processed information from the second hidden layer 1208 and generates the final output of the AI model 1200. The output of the AI model 1200 may be the AI analysis of an image or the generated data based on the AI analysis, depending on whether the AI model 1200 is used as the first AI model or the second AI model in the methods 100 and 200 shown in FIGS. 1 and 2 respectively.

The structure of the AI model 1200 represents the feed-forward network of a neural network, where information flows from the context data 1202 through the input layer 1204, then through the first hidden layer 1206 and the second hidden layer 1208, before reaching the output layer 1210. This architecture allows for the processing and transformation of input data to generate output based on the learned patterns and weights within the network.

In some aspects, a transformer network may comprise several key components that work together to process and generate sequential data. The key components may include an encoder, a decoder, attention mechanisms, and feed-forward neural networks.

In some aspects, transformer networks may be trained using a process called self-supervised learning. This training approach may involve presenting the model with large amounts of unlabeled data and allowing it to learn patterns and relationships within the data. The training process may include several steps. The transformer network may be initially pre-trained on a large corpus of data, such as text or images, to learn general features and patterns. After pre-training, the model may be further refined on task-specific data to adapt its knowledge to particular applications through fine-tuning. During training, the model may learn to focus on relevant parts of the input data through attention mechanisms, which may help in capturing long-range dependencies. The model's parameters may be updated using gradient descent and backpropagation algorithms to minimize the difference between predicted and actual outputs. Techniques such as dropout or weight decay may be employed to prevent overfitting and improve generalization. In some cases, the training process may involve iterative refinement, where the model's performance is evaluated and adjusted over multiple epochs to achieve accurate results.

In other examples, the first and second AI models may be implemented using various technical approaches and architectures. In some cases, the models may be based on neural networks for image analysis tasks, leveraging their ability to extract hierarchical features from visual data. The models may also utilize transfer learning techniques, where pre-trained models are fine-tuned on specific datasets relevant to the image analysis and text generation tasks. In some implementations, the AI models may incorporate attention mechanisms to focus on relevant parts of the input data, enhancing their ability to capture context and generate more accurate outputs. The models may be deployed on specialized hardware such as graphics processing units (GPUs) or tensor processing units (TPUs) to accelerate computation and improve performance. Additionally, the AI models may be implemented using distributed computing frameworks, allowing for parallel processing across multiple nodes to handle large-scale data and complex computations efficiently.

In some aspects, the methods and systems described above may include additional features and capabilities to handle updates, integrate external information, and customize AI-generated content. For instance, the system and methods may automatically prompt the user to regenerate descriptions when features or reference signs are added to images. This may occur, for example, when the user modifies an image in the application, such as by adding new elements or changing the positions of existing elements. Upon detecting these changes, the system may present a notification or dialog box to the user, asking whether they would like to regenerate the AI analysis and corresponding descriptions based on the updated image. If the user chooses to regenerate the descriptions, the system may repeat the relevant steps of the methods, using the updated image as input. This feature may enhance the flexibility and responsiveness of the system, allowing for dynamic updates to the AI analysis and generated descriptions as the image evolves.

In some cases, the system may retain user changes across iterations when regenerating descriptions. For example, if the user has previously adjusted the AI analysis or element labels for certain features in the image, these adjustments may be preserved when the AI analysis is regenerated. This may be achieved by storing the user-adjusted AI analysis or element labels in a persistent data store, such as a database or file system, and retrieving this data when the AI analysis is regenerated. This feature may enhance the efficiency and consistency of the system, reducing the need for the user to repeat adjustments for the same features across multiple iterations.

In some aspects, the system may integrate information from separate text documents, such as an invention disclosure, to provide further context for the AI. This may occur, for example, when the user uploads or inputs a text document into the application. The system may parse the text document, extracting relevant information and using it to augment the context data provided to the AI model. This additional context may enhance the accuracy and relevance of the AI analysis and generated descriptions, particularly for complex or specialized subject matter that may not be fully conveyed by the image alone.

In some cases, the system may be associated with a template and custom AI instructions to adjust the writing style of the AI. For example, the user may select a template from a library of pre-defined templates in the application, each corresponding to a different document type or writing style. The selected template may provide a structure or format for the generated descriptions, such as specific section headings, paragraph layouts, or citation styles. The user may also provide custom AI instructions, such as prompts or parameters, to guide the AI in generating text. The custom AI instructions may influence various aspects of the AI-generated text, such as the level of detail, technical complexity, or tone of voice. This feature may enhance the versatility and adaptability of the system, allowing for AI-generated content to be tailored to a wide range of document requirements and user preferences.

In the embodiments described above, the server may comprise a single server or network of servers. In some examples, the functionality of the server may be provided by a network of servers distributed across a geographical area, such as a worldwide distributed network of servers, and a user may be connected to an appropriate one of the network servers based upon, for example, a user location.

The above description discusses embodiments with reference to a single user for clarity It will be understood that in practice the system may be shared by a plurality of users, and possibly by a very large number of users simultaneously.

The embodiments described above are fully automatic. In some examples a user or operator of the system may manually instruct some steps of the method to be carried out.

In the described embodiments, the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and Blu-ray (RTM) disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term “computer” is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program.

Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the present disclosure.

Any reference to “an” item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” and the phrase “for example” are intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

In some aspects, the invention may be embodied as a non-transitory computer-readable medium storing instructions that, when executed by one or more processors, cause the one or more processors to perform operations for generating data using artificial intelligence based on image analysis. The operations may include obtaining an image, providing the image to a first AI model, generating an analysis of the image using the first AI model, providing the analysis to a user, receiving a primary user input adjusting the analysis to form a user-adjusted analysis, providing the user-adjusted analysis to a second AI model, and generating data using the second AI model based on the user-adjusted analysis.

The operations may further include extracting a feature from the image, generating an element label associated with the feature, providing a dataset to the user comprising the element label and an identifier of the feature, receiving a secondary user input adjusting the dataset to form a user-adjusted dataset, and using the user-adjusted dataset to adjust the analysis of the image or further adjust the user-adjusted analysis of the image.

In some cases, the non-transitory computer-readable medium may store additional instructions for performing various aspects of the image analysis and data generation process. For example, the operations may include presenting a user interface having an editable text area comprising the analysis of the image, wherein receiving the primary user input adjusting the analysis of the image to form a user-adjusted analysis includes receiving an edit of the analysis of the image in the editable text area.

The operations may also include presenting the generated data to the user in a document editor. In some implementations, the data generation process may involve generating the data using the second AI model based on the user-adjusted analysis and at least one of an additional instruction provided by the user and other pre-existing data input by the user to the document editor.

The non-transitory computer-readable medium may store instructions for implementing various features and functionalities, such as retaining user changes across iterations when regenerating descriptions, integrating information from separate text documents to provide further context for the AI, and associating templates and custom AI instructions to adjust the writing style of the AI-generated content.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible.

Accordingly, the described aspects are intended to embrace all such alterations. modifications, and variations that fall within the scope of the appended claims.

### INDUSTRIAL APPLICABILITY

The present disclosure relates to computer-implemented methods and systems for image analysis and data generation, and more particularly to a method and system for analyzing figures for patent applications using artificial intelligence models and generating data based on user-verified image analysis. Numerous modifications to the present invention will be apparent to those skilled in the art in view of the foregoing description. Accordingly, this description is to be construed as illustrative only and is presented for the purpose of enabling those skilled in the art to make and use the invention. The exclusive rights to all modifications which come within the scope of the appended claims are reserved.

1. A method for generating data using artificial intelligence based on image analysis, the method comprising:
obtaining, by a computing device, an image;
providing the image to a first artificial intelligence model;
generating, using the first artificial intelligence model, an analysis of the image;
providing the analysis of the image to a user;
receiving a primary user input adjusting the analysis of the image to form a user-adjusted analysis;
providing the user-adjusted analysis to a second artificial intelligence model; and
generating data using the second artificial intelligence model based on the user-adjusted analysis.

2. The method of claim 1, further comprising:
extracting a feature from the image;
generating an element label associated with the feature;
providing a dataset to the user, wherein the dataset comprises the element label and a reference to an associated feature;
receiving a secondary user input adjusting the dataset to form a user-adjusted dataset; and
using the user-adjusted dataset to:
adjust the analysis of the image; or
further adjust the user-adjusted analysis of the image.

3. The method of claim 2, wherein using the user-adjusted dataset to adjust the analysis of the image comprises:
providing the user-adjusted dataset to the first artificial intelligence model prior to generating the analysis of the image, such that the analysis of the image is based on the user-adjusted dataset.

4. The method of claim 2, wherein using the user-adjusted dataset to further adjust the user-adjusted analysis of the image comprises:
providing the user-adjusted dataset to the first artificial intelligence model after receiving the primary user input adjusting the analysis of the image to form a user-adjusted analysis; and
automatically updating the user-adjusted analysis of the image based on the user-adjusted dataset.

5. The method of claim 2, wherein the secondary user input comprises an adjustment to the element label of the dataset, and adjusting the analysis of the image comprises:
adjusting the analysis of the image based on the adjustment to the element label.

6. The method of claim 1, wherein providing the analysis of the image to the user comprises:
presenting a user interface having an editable text area comprising the analysis of the image, wherein receiving the primary user input adjusting the analysis of the image to form a user-adjusted analysis comprises:
receiving an edit of the analysis of the image in the editable text area.

7. The method of claim 6, wherein the user interface comprises one or more user interface elements for adjusting, regenerating, or saving the analysis of the image.

8. The method of claim 1, further comprising presenting the generated data to the user in a user interface comprising a document editor.

9. The method of claim 8, wherein generating the data using the second artificial intelligence model based on the user-adjusted analysis further comprises:
generating the data using the second artificial intelligence model based on the user-adjusted analysis and at least one of:
an additional instruction provided by the user; and
other pre-existing data input by the user to the document editor.

10. The method of claim 1, wherein the first artificial intelligence model is the same model as the second artificial intelligence model.

11. A computing system for generating data using artificial intelligence based on image analysis, the computing system comprising:
a processor; and
a memory storing instructions that, when executed by the processor, cause the computing system to:
obtain an image;
provide the image to a first artificial intelligence model;
generate, using the first artificial intelligence model, an analysis of the image;
provide the analysis of the image to a user;
receive a primary user input adjusting the analysis of the image to form a user-adjusted analysis;
provide the user-adjusted analysis to a second artificial intelligence model; and
generate data using the second artificial intelligence model based on the user-adjusted analysis.

12. The computing system of claim 11, wherein the memory storing instructions further cause the computing system to:
extract a feature from the image;
generate an element label associated with the feature;
provide a dataset to the user, wherein the dataset comprises the element label and a reference to its associated feature;
receive a secondary user input adjusting the dataset to form a user-adjusted dataset; and
use the user-adjusted dataset to:
adjust the analysis of the image; or
further adjust the user-adjusted analysis of the image.

13. The computing system of claim 12, wherein the memory storing instructions cause the computing system to use the user-adjusted dataset to adjust the analysis of the image by:
providing the user-adjusted dataset to the first artificial intelligence model prior to generating the analysis of the image, such that the analysis of the image is based on the user-adjusted dataset.

14. The computing system of claim 12, wherein the memory storing instructions cause the computing system to use the user-adjusted dataset to further adjust the user-adjusted analysis of the image by:
providing the user-adjusted dataset to the first artificial intelligence model after receiving the primary user input adjusting the analysis of the image to form a user-adjusted analysis; and
automatically updating the user-adjusted analysis of the image based on the user-adjusted dataset.

15. The computing system of claim 12, wherein the secondary user input comprises an adjustment to the element label of the dataset, and the memory storing instructions cause the computing system to adjust the analysis of the image by:
adjusting the analysis of the image based on the adjustment to the element label.

16. The computing system of claim 11, further comprising a user interface, wherein the user interface is configured to:
present an editable text area comprising the analysis of the image; and
receive the primary user input comprising an edit of the analysis of the image in the editable text area.

17. The computing system of claim 16, wherein the user interface comprises one or more user interface elements for adjusting, regenerating, or saving the analysis of the image.

18. The computing system of claim 11, wherein the memory storing instructions further cause the computing system to present the generated data to the user in a user interface comprising a document editor.

19. The computing system of claim 18, wherein the memory storing instructions further stores instructions that, when executed by the processor, cause the computing system to:
generate the data using the second artificial intelligence model based on the user-adjusted analysis and at least one of:
an additional instruction provided by the user; and
other pre-existing data input by the user to the document editor.

20. The computing system of claim 11, wherein the first artificial intelligence model is the same model as the second artificial intelligence model.

21. A method for improving an efficiency and accuracy of a system for drafting a patent application by utilizing artificial intelligence, comprising:
receiving, through a user interface, a figure;
providing the figure to a first artificial intelligence model;
generating, using the first artificial intelligence model, a first analysis of the figure;
displaying the first analysis of the figure to a user;
providing the figure and the first analysis to a second artificial intelligence model;
generating, using the second artificial intelligence model, a second analysis of the figure;
displaying the second analysis of the figure to a user;
providing the figure, the first analysis, and the second analysis to a third artificial intelligence model;
generating, using the third artificial intelligence model, text related to the figure; and
displaying the generated text to the user.

22. A system with improved efficiency and performance in drafting a patent application, comprising:
a client device configured to display a user interface;
a server communicatively coupled to the client device; and
a large language model server communicatively coupled to the server,
wherein the server is configured to:
receive, through the user interface, a figure;
provide the figure to the large language model server;
receive a first analysis of the figure from the large language model server;
receive user feedback from the client device in response to the first analysis of the figure;
provide the figure and the first analysis of the figure to the large language model server;
receive a second analysis of the figure from the large language model server;
receive a second analysis of the figure from the large language model server;
receive user feedback from the client device in response to the second analysis of the figure;
provide the figure, the first analysis, and the second analysis of the figure to the large language model server;
receive generated text from the large language model server; and
display the generated text to the user interface.

23. A non-transitory computer-readable medium storing instructions that, when executed by a processor, cause the processor to perform operations for improving an efficiency and a performance of a system for drafting a patent application, the operations comprising:
receiving, through a user interface, a figure;
providing the figure to a first artificial intelligence model;
generating, using the first artificial intelligence model, a first analysis of the figure;
displaying the first analysis of the figure to a user;
providing the figure and the first analysis to a second artificial intelligence model;
generating, using the second artificial intelligence model, a second analysis of the figure;
displaying the second analysis of the figure to a user;
providing the figure, the first analysis, and the second analysis to a third artificial intelligence model;
generating, using the third artificial intelligence model, text related to the figure; and
displaying the generated text to the user.

24. The method of claim 21, wherein the step of generating, using the first artificial intelligence model, the first analysis of the figure includes extracting one or more reference numerals from the figure and generating reference names for the one or more reference numerals.

25. The method of claim 21, wherein the first artificial intelligence model, the second artificial intelligence model, and the third artificial intelligence model are the same artificial intelligence model.
